(19) United States
(12) Patent Application Publication
(10) Pub. No.: US 2015/0266761 A1
(43) Pub. Date: Sep. 24, 2015

(54) Systems and Methods for Modifying Waste Fluids

(71) Applicant: EcoStream Water Recycling Corporation, Newark, OH (US)

(72) Inventor: Trace Joseph JOHNSON, Newark, OH (US)

(73) Assignee: EcoStream Water Recycling Corporation, Newark, OH (US)

(21) Appl. No.: 14/220,209

(22) Filed: Mar. 20, 2014

(51) Int. Cl. C02F 9/00; C02F 1/70; C02F 1/66; C02F 1/32; C02F 1/00

(52) U.S. Cl. CPC C02F 9/00; C02F 1/325; C02F 1/008; C02F 1/66; C02F 1/70

(57) ABSTRACT

Systems and/or methods for use with and/or including processing apparatus which use clean fluids in processes which results in the clean fluid becoming waste fluid. The systems and/or methods modify the waste fluid generated by the processing apparatus, analyze the modified waste fluid to determine whether the systems and/or methods are operating normally and/or whether the modified waste fluid has become clean fluid, and return the modified waste fluid for use in the processing apparatus, if the systems and/or methods are operating normally and/or the modified waste fluid has become clean fluid.

Provided are systems and methods for modifying waste fluids such that the waste fluids may be reused for their original purpose.

There are many residential, commercial and industrial primary processes which utilize incoming clean fluids and generate waste fluids from the clean fluids. In many cases, the waste fluids are merely disposed of, such as by flushing the waste fluids into a sewer system. In other cases, the waste fluids may be processed before disposal, or may be processed for use in secondary processes which do not require the utmost clean fluids. In any case, the primary processes use large amounts of clean fluids, which leads to substantial costs associated with supplying the clean fluids to the primary processes. Furthermore, disposal of the waste fluids also leads to substantial costs, which may be even higher than the costs of supplying the clean fluids to the primary processes. In certain instances, the clean and waste fluids comprise liquids, and in some instances the liquid is water.

In residential applications, for example, the cost of disposal of waste water in the sewer system may be directly proportional to the cost of the clean water supplied to the residence. In some instances, the sewer fees are higher than the water fees, because of the significant cost associated with processing the waste water before it can safely be reintroduced into the environment.

In commercial and industrial applications, for example, waste water may be metered separately from supplied clean water, so that the costs associated with treating the waste water may be more accurately assessed. Furthermore, the waste water may be analyzed prior to or during disposal, in order to determine whether the waste water contains contaminants which further increases the cost of processing, either before final disposal or upon final waste water treatment. If certain contaminants are present, and/or are present at certain amounts, a surcharge may be applied to the fees associated with disposal of the waste water. For example, the amount of microbes present in the waste water can be measured by determining the biological oxygen demand (“BOD”) of the waste water, and if the BOD is measured to be higher than a certain amount, a surcharge may be assessed for processing the waste water at a sewer treatment facility.

The costs associated with supplying clean water typically do not fully account for the fact that the mere removal of water from the ecosystem may be damaging to the ecosystem, including human and other life. Furthermore, water collected from the ecosystem may need to be treated prior to supplying the clean water to end users.

The costs associated with treating waste water typically do not fully account for the harmful effect treatment chemicals may have on the ecosystem, including human and other life. Furthermore, manufacturing of treatment chemicals may also have a detrimental effect on the ecosystem which is not fully accounted for in the cost of the chemicals and/or in the cost of treatment.

Supplying clean water and treating waste water also requires the use of resources and energy to collect, transport, use and treat both clean water and waste water, including the costs associated with manufacturing and supplying treatment chemicals for treating both clean water prior to use and waste water after use.

The problems discussed above with regard to supplying clean water and disposing of waste water may be analogous to problems with regard to supplying and disposing of other liquids and/or fluids.

In certain circumstances, it has been known to treat waste fluids prior to disposal, in order to remove contaminants and reduce the costs associated with disposal. However, this activity has its own costs, and does nothing to alleviate the costs of supplying clean fluids.

Previous attempts have been made at treating waste fluids from primary processes for use in secondary processes. However, in many circumstances, such treatment is not cost-effective, because the costs of transporting the waste fluid significant distances to a treatment process and then, after treatment, to the secondary process may be cost-prohibitive. These costs may include, for example, the costs of large pumps and long conduits needed to transport the fluid. Furthermore, space is typically limited in manufacturing facilities, and large pumps and long conduits take up significant amounts of space, which may not be available in some manufacturing facilities.

What is needed are systems and/or methods for treating waste fluids such that they may be reused in the primary process which generates the waste fluids. The subject systems and/or methods may reduce the consumption of clean fluids and costs associated therewith, reduce the generation of waste fluids which must be disposed of and the costs associated therewith, reduce the environmental impacts of removing fluids from the environment and/or of manufacturing and using treatment chemicals, and/or minimize the cost of transporting the waste fluids for treatment and/or reuse.

Embodiments of the disclosed subject matter are disclosed with reference to the accompanying drawings and are for illustrative purposes only. The subject matter is not limited in its application to the details of construction or the arrangement of the components illustrated in the drawings. Like reference numerals are used to indicate like components, unless otherwise indicated.

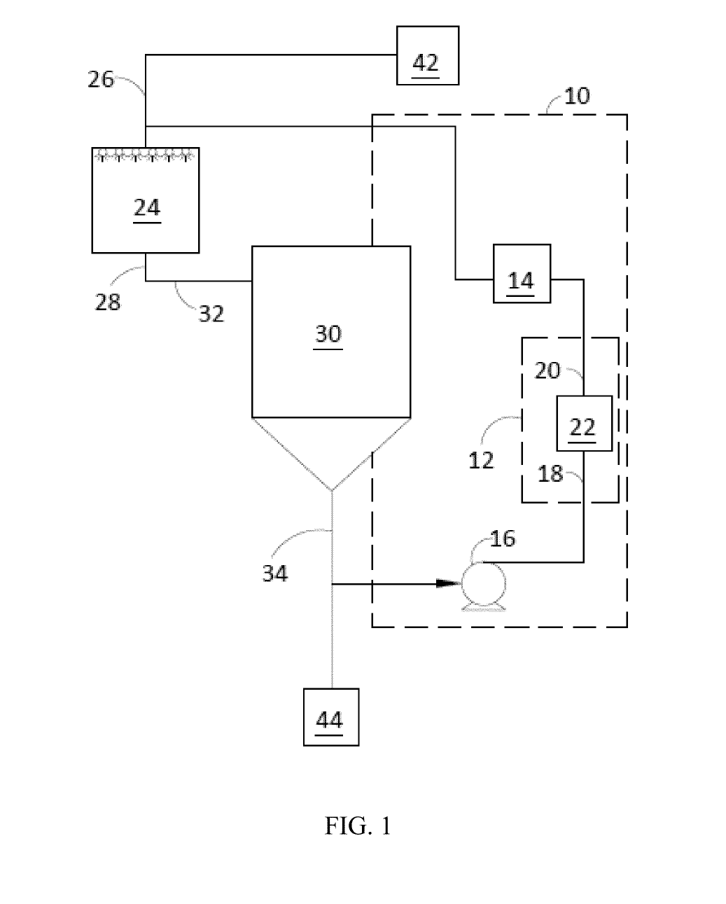

FIG. 1 illustrates an embodiment of a subject system as disclosed herein.

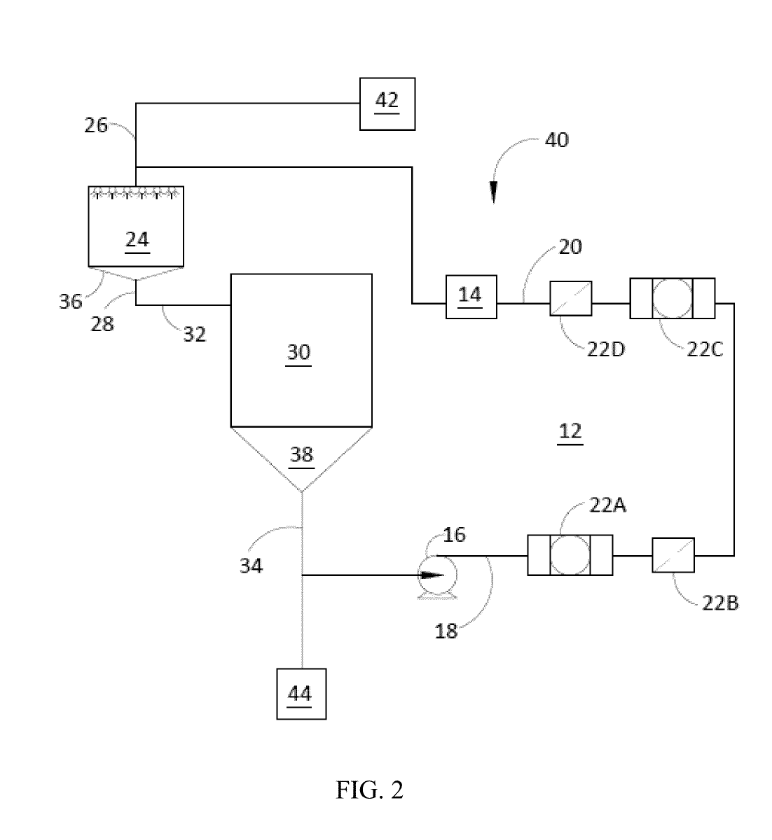

FIG. 2 illustrates an embodiment of a subject system as disclosed herein.

Provided is a system for use with a processing apparatus comprising a clean fluid entry portion and a waste fluid discharge portion, wherein the processing apparatus uses clean fluid in a process which results in the clean fluid becoming waste fluid; the system comprising: (a) a fluid modification apparatus comprising: (i) a first end capable of being in fluid communication with the waste fluid discharge portion; (ii) a second end capable of being in fluid communication with the clean fluid entry portion; and (iii) at least one fluid modification device in fluid communication with the first end and the second end, wherein the at least one fluid modification device modifies the waste fluid; (b) at least one analyzing device which determines: (i) whether the system is operating normally; and/or (ii) whether the modified waste fluid has become clean fluid; and (c) at least one fluid transport apparatus which returns the modified waste fluid to the processing apparatus, if the at least one analyzing device determines that the system is operating normally and/or that the modified waste fluid has become clean fluid. In certain embodiments, the waste fluid may comprise a liquid. In certain embodiments, the waste fluid may comprise water.

As used herein the term “clean fluid” means a fluid suitable for use in the processing apparatus, for the specific purpose for which the processing apparatus uses the clean fluid. As used herein, the term “waste fluid” means a fluid which is discharged from the processing apparatus after use in the processing apparatus. For example, the clean fluid may comprise a clean fluid supplied by an outside supplier, such as clean water supplied by a local water system. The clean fluid may also comprise a modified waste fluid which has been modified such that it may be used equivalently to the clean fluid supplied by an outside supplier. The systems are also suitable for use with processes which require expensive deionized water as the clean fluid, such as processes used by the semiconductor and medical device industries.

As used herein, the term “in fluid communication” means fluid may be transported directly or indirectly between two or more components, via now known or hereafter discovered means.

As used herein, the term “fluid modification device” means any device which modifies a fluid in any manner now known or hereafter discovered. For example, but without limitation, a fluid modification device: may alter any properties of a fluid, such as the temperature, pressure and/or chemical composition of the fluid; may add matter to the fluid; may remove matter from the fluid; or may alter matter present in the fluid.

As used herein, the term “analyzing device” means a device which is capable of: (i) determining whether the system is operating normally by any manner now known or hereafter discovered; and/or (ii) analyzing the contents and/or properties of a fluid by any manner now known or hereafter discovered.

By “operating normally”, what is meant is that the system is operating as designed and intended as described herein without fault or error, such that the system is capturing the waste fluid from the processing apparatus, transporting the waste fluid through the fluid modification apparatus, and returning the modified waste fluid to the processing apparatus.

With regard to the analyzing device being capable of determining whether the system is operating normally, in certain embodiments, the analyzing device may be able to determine at least one of: (i) whether fluid is flowing through the system, (ii) whether the power requirements for transporting fluid through the system indicate that there is a problem within the system, or (iii) whether a component of the system has failed and/or has been removed from the system. In embodiments in which the analyzing device only determines whether the system is operating normally, it is assumed that the system is modifying the waste fluid such that the modified waste fluid becomes clean fluid, and ongoing analysis of the contents and/or properties of the modified waste fluid is not required. In this circumstance, it may be desirable to perform maintenance on the system on regular intervals.

As used herein, the term “fluid transport apparatus” means an apparatus which is capable of moving a fluid by any manner now known or hereafter discovered. For example, but without limitation, a fluid transport apparatus may comprise a pump. For example, but without limitation, the pump may comprise a gear pump, a screw pump, a progressive cavity pump, a roots-type pump, a peristaltic pump, a plunger pump, a triplex-style pump, a flexible impeller pump, rotolliptic pump, a hydraulic ram pump, a centrifugal pump, a radial flow pump, an axial flow pump, a mixed flow pump, an educator jet pump, a gravity pump, a steam pump, or a valveless pump.

Without limitation, examples of the processing apparatus include: (i) apparatus which rinse and/or wash items, such as food and/or beverage containers, components of manufacture or finished manufactured products, such as quartz components for the semiconductor industry; or (ii) apparatus which are used to cool and/or clean moving parts of an associated apparatus, such as a piston cooling apparatus. The processing apparatus utilizes a clean fluid in a process which results in the clean fluid becoming a waste fluid.

By way of example, and not in limitation, the processing apparatus may comprise a milk jug rinsing/washing apparatus. The milk jug rinsing/washing apparatus draws clean water from a source of clean water (such as water provided by a governmental water system), optionally adds a washing agent to the clean water, and rinses/washes the milk jugs with the clean water. Once the clean water comes into contact with the milk jug, it collects any milk residue and other matter from the exterior of the milk jug, and the clean water becomes waste water. Conventionally, the waste water generated by the milk jug rinsing/washing apparatus is merely disposed of. In some instances, the waste water is allowed to merely drop to the floor and run to a drain, the drain being in fluid communication with a sewer, such as a governmental sewer system. In this example, the clean water must meet regulatory requirements, such as including maximum levels of contaminants and/or microbes. Such regulatory requirements differ from jurisdiction to jurisdiction.

Some regulatory requirements require that the BOD of water containing microbes be limited to a certain maximum level in order for the water to be suitable for use in rinsing/washing milk jugs. Thus, in certain embodiments, the subject system(s) may be capable of eliminating and/or removing microbes from the water, in order to decrease the BOD of the water below the regulatory maximum. Systems for decreasing the BOD of water for use in rinsing/washing milk jugs have previously been theorized. However, in order to minimize costs, such that the systems would be cost-effective for use with milk jug rinsing/washing apparatus, these theories focused on using a small number of small physical filters to remove contaminants. The previous attempts also did not consider the use of UV radiation generators. For these reasons, the theoretical systems were never designed, built or tested.

In an embodiment, a system is provided to capture the waste water from the milk jug rinsing/washing apparatus, modify the waste water, determine whether the modified waste water has become clean water, and return the clean water to the milk jug rinsing/washing apparatus. Thus, in order to become clean water, the modified waste water must meet the regulatory requirements mentioned above. The modified waste water may then be used equivalently to the clean water supplied from the source of clean water. The system thus collects and reuses waste water in order to reduce resource consumption, including financial resources, reduce negative environmental impacts, and/or reduce safety hazards, by keeping the waste water from falling to the floor, where it may cause a human slip hazard.

In certain embodiments, subject systems may be suitable for use with processes used in the following industries: beverage manufacturing, including dairy beverages, juice beverages, soda beverages, and alcoholic beverages; food manufacturing; silicon manufacturing; quartz manufacturing; and/or mechanical system manufacturing.

In certain embodiments, it may not be necessary to determine whether the modified waste fluid has become clean fluid before returning the modified waste fluid to the processing apparatus. For example, the clean fluid used in the processing apparatus may not be subject to regulatory requirements, or the processing apparatus may not create waste fluid which needs to be tested for contaminants before reuse.

In an embodiment, the provided system may comprise: (a) a fluid modification apparatus comprising: (i) a first end capable of being in fluid communication with the waste fluid discharge portion; (ii) a second end capable of being in fluid communication with the clean fluid entry portion; and (iii) at least one fluid modification device in fluid communication with the first end and the second end, wherein the at least one fluid modification device modifies the waste fluid; (b) at least one analyzing device which determines whether the system is operating normally; and (c) at least one fluid transport apparatus which returns the modified waste fluid to the processing apparatus, if the at least one analyzing device determines that the system is operating normally.

In an embodiment, the provided system may comprise: (a) a fluid modification apparatus comprising: (i) a first end capable of being in fluid communication with the waste fluid discharge portion; (ii) a second end capable of being in fluid communication with the clean fluid entry portion; and (iii) at least one fluid modification device in fluid communication with the first end and the second end, wherein the at least one fluid modification device modifies the waste fluid; (b) at least one analyzing device which determines whether the modified waste fluid has become clean fluid; and (c) at least one fluid transport apparatus which returns the modified waste fluid to the processing apparatus, if the at least one analyzing device determines that the modified waste fluid has become clean fluid.

In certain embodiments, the at least one fluid modification device comprises at least one of: at least one filter; at least one UV radiation generator; at least one heat exchanger; at least one pH modifier; at least one chemical introduction device; at least one deionization device; at least one sediment removal device; at least one strainer; at least one biological oxygen demand reducing device; at least one deodorizing device; or at least one decoloring device. The above fluid modification devices may comprise any such device which is now known or hereafter discovered. In certain embodiments, the fluid modification apparatus comprises a plurality of the at least one fluid modification devices arranged in series and/or in parallel.

In certain embodiments, the at least one filter comprises a filter having a pore size of about 0.2 to about 100 μm. By “pore size”, what is meant is that the filter will remove particles of matter having a size which is larger than the pore size. In certain embodiments, the at least one filter comprises at least one filter having a pore size of about 0.2 to about 5 μm and at least one filter having a pore size of about 10 to about 50 μm. In certain embodiments, the at least one filter comprises at least one polypropylene filtration medium.

In certain embodiments, the at least one UV radiation generator may comprise at least one of: (i) a lamp which generates radiation at a wavelength of about 254 nm; (ii) a lamp which generates radiation at a wavelength of about 185 nm; (iii) a lamp which generates radiation which provides an antimicrobial effect; (iv) a lamp which reduces the biological oxygen demand of the waste fluid; (v) a lamp which generates radiation which penetrates the DNA and/or RNA of bacteria; (vi) a lamp which generates radiation which at least partially disrupts the reproductive abilities of biological organisms; or (vii) a lamp which generates radiation which generates ozone in water.

In certain embodiments, the at least one strainer may comprise a strainer which comprises a medium through which the waste fluid is fed by gravity and/or pressure. The strainer may comprise a medium which is capable of filtering particles having a size of about 35 μm to about 7 mm. In certain embodiments, the at least one strainer may be used to reduce the amount of particles which must be removed by a filter.

In certain embodiments, the at least one sediment removal device may comprise a basin which allows particles to settle out of the waste fluid, and a means of removing the particles from the bottom of the basin and/or a means for removing the waste fluid from the basin after the particles have settled out of the waste fluid.

In certain embodiments, the at least one heat exchanger may comprise any now known or hereafter developed heat exchanger. For example, but without limitation the at least one heat exchanger may comprise at least one of a double pipe heat exchanger, a shell and tube heat exchanger, a plate heat exchanger, a plate and shell heat exchanger, an adiabatic wheel heat exchanger, a plate fin heat exchanger, a pillow plate heat exchanger, a fluid heat exchanger, a dynamic craped surface heat exchanger, or a phase-change heat exchanger.

In certain embodiments, the system(s) described herein may have a small footprint, such that the system(s) may fit inside an already-existing manufacturing facility without affecting the operation of the manufacturing facility. As used herein, the term “footprint” means the amount of floor space occupied by the system. In certain embodiments, the system may have a footprint of less than or equal to about 20 ft².

In certain embodiments, the system(s) described herein may further comprise at least one logic controller for controlling operation of the system. The at least one logic controller may be in electronic communication with any or all of the components of the system(s) in order to control the function of the system(s).

In certain embodiments, the system(s) may be modular. As used herein, the term “modular”, when referring to the system(s) as a whole, means that the modular system is self-contained, such that it may be shipped and installed as a single unit, optionally with a minimum amount of connections needing to be made to the processing apparatus and other resources at the installation site.

In certain embodiments, the system(s) may be comprised of modular components. As used herein the term “modular components” refers to components which are separate and distinct and may be maintained and/or replaced without disturbing the other components of the system(s).

In certain embodiments, the at least one analyzing device may be capable of determining at least one of: the biological oxygen demand of the modified waste fluid; the pH of the modified waste fluid; the amount of ions present in the modified waste fluid; the temperature of the modified waste fluid; the amount of organic matter present in the modified waste fluid; the total suspended solids present in the modified waste fluid; or the color of the modified waste fluid.

Also provided is a system comprising: (a) a processing apparatus comprising a clean fluid entry portion and a waste fluid discharge portion, wherein the processing apparatus uses clean fluid in a process which results in the clean fluid becoming waste fluid; (b) a fluid modification apparatus comprising: (i) a first end in fluid communication with the waste fluid discharge portion; (ii) a second end in fluid communication with the clean fluid entry portion; and (iii) at least one fluid modification device in fluid communication with the first end and the second end, wherein the at least one fluid modification device modifies the waste fluid; (c) at least one analyzing device which determines: (i) whether the system is operating normally; and/or (ii) whether the modified waste fluid has become clean fluid; and (d) at least one fluid transport apparatus which returns the modified waste fluid to the processing apparatus, if the at least one analyzing device determines that the system is operating normally and/or that the modified waste fluid has become clean fluid.

In certain embodiments, the system may further comprise at least one reservoir comprising at least one of: (i) an inlet in fluid communication with the waste discharge portion of the processing apparatus and an outlet in fluid communication with the first end of the fluid modification apparatus; or (ii) an inlet in fluid communication with the second end of the fluid modification apparatus and an outlet in fluid communication with the clean fluid entry portion of the processing apparatus. The at least one reservoir may contain from about 10 to about 60 gallons of fluid. The at least one reservoir may comprise a cone-shaped bottom.

In certain embodiments, the system may further comprise a waste fluid collector in fluid communication with: (i) the inlet of the at least one reservoir; or (ii) the first end of the fluid modification apparatus.

In addition to the components described above, in certain embodiments, the subject system(s) may include other devices in order for the system(s) to operate as described and intended. For example, the system(s) may include sensors, such as temperature sensors, pressure sensors, or liquid level sensors. The system(s) may also include valves, such as solenoid valves, check valves or three-way valves. The system(s) may also include various types and/or sizes of conduits, such as pipes or tubes, and the type and/or size of conduit used may differ throughout the system(s). The system(s) may also include nozzles at various points throughout the system(s).

Also provided is a method of modifying a waste fluid comprising: capturing the waste fluid from a process which results in a clean fluid becoming the waste fluid; modifying the waste fluid; ensuring that said modifying the waste fluid is occurring and/or analyzing the modified waste fluid to determine whether it has become clean fluid; and if said modifying the waste fluid is occurring and/or if the modified waste fluid has become clean fluid, returning the clean fluid to the process for reuse. In certain embodiments, the waste fluid may comprise a liquid. In certain embodiments, the waste fluid may comprise water.

In certain embodiments, the method may further comprise performing a process which uses clean fluid and results in the clean fluid becoming the waste fluid.

In certain embodiments, modifying the waste fluid may comprise at least one of: filtering the waste fluid; subjecting the waste fluid to UV radiation; modifying the temperature and/or pressure of the waste fluid; modifying the pH of the waste fluid; introducing chemicals into the waste fluid; deionizing the waste fluid; removing sediment from the waste fluid; straining the waste fluid; reducing the BOD of the waste fluid; deodorizing the waste fluid; or decoloring the waste fluid.

In certain embodiments, the method may further comprise storing the waste fluid before and/or after performing one or more than one step of the method.

In certain embodiments, modifying the waste fluid may comprise passing the waste fluid through at least one fluid modification device. The at least one fluid modification device may comprise at least one of: at least one filter; at least one UV radiation generator; at least one heat exchanger; at least one pH modifier; at least one chemical introduction device; at least one deionization device; at least one sediment removal device; at least one strainer; at least one biological oxygen demand reducing device; at least one deodorizing device; or at least one decoloring device.

In certain embodiments, the at least one filter may comprise a filter having a pore size of about 0.2 to about 100 μm. In certain embodiments, the at least one filter may comprise at least one filter having a pore size of about 0.2 to about 5 μm and at least one filter having a pore size of about 10 to about 50 μm.

In certain embodiments, the at least one UV radiation generator comprises at least one of: (i) a lamp which generates radiation at a wavelength of about 254 nm; (ii) a lamp which generates radiation at a wavelength of about 185 nm; (iii) a lamp which generates radiation which provides an antimicrobial effect; (iv) a lamp which reduces the biological oxygen demand of the waste fluid; (v) a lamp which generates radiation which penetrates the DNA and/or RNA of bacteria; (vi) a lamp which generates radiation which at least partially disrupts the reproductive abilities of biological organisms; or (vii) a lamp which generates radiation which generates ozone in water.

In certain embodiments, analyzing the modified waste fluid to determine whether it has become clean fluid may be based on at least one of: the biological oxygen demand of the modified waste fluid; the pH of the modified waste fluid; the amount of ions present in the modified waste fluid; the temperature of the modified waste fluid; the amount of organic matter present in the modified waste fluid; the total suspended solids present in the modified waste fluid; or the color of the modified waste fluid.

Referring to FIG. 1, a system 10 is provided, associated with processing apparatus 24. The system 10 includes a fluid modification apparatus 12 which includes a first end 18, a second end 20, and at least one fluid modification device 22. The first end 18 of the fluid modification apparatus 12 is in fluid communication with a waste fluid discharge portion 28 of the processing apparatus 24 via an inlet 32 of a reservoir 30, an outlet 34 of the reservoir 30 and at least one fluid transport apparatus 16 (such as a pump). The second end 20 of the fluid modification apparatus 12 is in fluid communication with a clean fluid entry portion 26 of the processing apparatus 24 via at least one analyzing device 14. The analyzing device 14 may or may not be in fluid communication with the system.

In use, the embodiment of FIG. 1 may be described as follows. A clean fluid is provided from a clean fluid source 42 to the clean fluid entry portion 26 of the processing apparatus 24. The processing apparatus 24 utilizes the clean fluid in a process which results in the clean fluid becoming a waste fluid. The waste fluid is discharged from the processing apparatus 24 via the waste fluid discharge portion 28. An optional reservoir 30 collects the waste fluid via the inlet 32. The waste fluid leaves the reservoir 30 via outlet 34, and the fluid transport apparatus 16 transports the fluid to the first end 18 of the fluid modification apparatus 12. The at least one fluid modification device 22 modifies the waste fluid and discharges the waste fluid via second end 20. The at least one analyzing device 14 determines whether the system 10 is operating normally and/or analyzes the modified waste fluid to determine whether the modified waste fluid has become a clean fluid. If the system 10 is operating normally and/or the modified waste fluid is determined to be clean fluid, the fluid modification apparatus 12 returns the clean fluid to the clean fluid entry portion 26 of the processing apparatus 24. If the system 10 is not operating normally and/or the modified waste fluid is determined to not be clean fluid, the fluid modification apparatus causes the system to discharge the waste fluid to a waste fluid disposal 44, such as a sewer drain. The embodiment of FIG. 1 also comprises any necessary conduits, valves or other known components in order to make the embodiment function as described. The embodiment of FIG. 1 may comprise a logic controller (not shown) which controls the features described in this paragraph in a suitable manner to provide the appropriate functionality described.

Referring to FIG. 2, a system 40 is provided, comprising many of the components illustrated in FIG. 1. In use, the embodiment of FIG. 2 may be described as follows. Clean water is provided from clean fluid source 42 to the clean fluid entry portion 26 of the processing apparatus 24. The processing apparatus 24 utilizes the clean water in a process, such as a milk jug rinsing/washing process, which results in the clean water becoming waste water. The waste water is discharged from the processing apparatus 24 via a waste fluid collector 36 and the waste fluid discharge portion 28. An optional reservoir 30, having an optional cone-shaped bottom 38, collects the waste fluid via the inlet 32. The waste fluid leaves the reservoir 30 via outlet 34, and the fluid transport apparatus 16 (such as a pump) transports the fluid to the first end 18 of the fluid modification apparatus 12. The fluid modification devices 22A, 22B, 22C, 22D, modify the waste water and discharge the waste water via second end 20. The fluid modification device 22A may comprise a filter, such as a 20 μm polypropylene filter. The fluid modification device 22B may comprise a UV radiation generator comprising a lamp which generates radiation at a wavelength of about 254 nm. The fluid modification device 22C may comprise a filter, such as a 1 μm polypropylene filter. The fluid modification device 22D may comprise a UV radiation generator which generates radiation which provides an antimicrobial effect and/or a lamp which generates radiation which generates ozone in the waste water.

The at least one analyzing device 14 determines whether the system 40 is operating normally and/or analyzes the modified waste fluid to determine whether the modified waste fluid has become a clean fluid. If the system 40 is operating normally and/or the modified waste fluid is determined to be clean fluid, the system 40 returns the clean fluid to the clean fluid entry portion 26 of the processing apparatus 24. If the system 40 is not operating normally and/or the modified waste fluid is determined to not be clean fluid, the fluid modification apparatus causes the system to discharge the waste fluid to a waste fluid disposal 44, such as a sewer drain.

The system 40 also comprises any necessary conduits, valves or other known components in order to make the embodiment function as described. The system 40 may comprise a logic controller associated with the various components described above, as well as with any valves which may be present in the system 40, in a suitable manner to provide the appropriate functionality described.

In certain embodiments, the components of the systems illustrated in FIGS. 1 and 2 and described above may be placed in any order which allows for the system to operate as described and intended. For example, the fluid transport apparatus may be placed in one or more numerous positions within the system(s) and still allow the system to function as intended. Similarly, the optional reservoir may be placed in one or more numerous positions throughout the system. Other features of the system may also be placed in one or more numerous positions throughout the system.

It is also possible, in certain embodiments, to place the various system components in parallel. For example, if a plurality of fluid modification devices are used, they may be placed in series and/or in parallel. Similarly, the at least one analyzing device may be placed in series and/or in parallel with the other components of the system. The at least one fluid transport apparatus may also be placed in series and/or in parallel with the other system components.

The following example is set forth merely to further illustrate the subject systems and/or methods. The illustrative example should not be construed as limiting the subject matter in any manner, and represents specific non-limiting embodiments of the subject matter.

Clean water enters a milk jug rinsing/washing apparatus from a source of clean water, such as a governmental water system, rinses/washes the milk jugs, and exits the apparatus as waste water. A collector collects the waste water and conveys it to a reservoir, such as a 30 or 60 gallon tank. The reservoir comprises two level sensors, one near the bottom of the reservoir and one near the top of the reservoir. The level sensors are in electronic communication with a logic controller. The reservoir is in fluid communication with a conduit comprising a valve, which determines whether the waste water in the reservoir is fed to a sewer drain. The valve is also in electronic communication with the logic controller. When the valve is in position to feed the waste water to the system, the system is in “recycle mode”. When the valve is in position to feed the waste water to the sewer drain, the system is in “maintenance mode”.

When the system is in recycle mode, a pump, such as a pump comprising a three-quarter horsepower motor, transports the waste water from the reservoir through the system. The pump is capable of transporting from about 15 L/min to about 36 L/min of water. The waste water travels first to a first fluid modification device comprising a filter, such as a 20 μm polypropylene filter. The waste water then travels to a second fluid modification device comprising a UV radiation generator, such as a UV lamp which emits radiation at a wavelength of about 254 nm capable of killing microbes. The waste water then proceeds to a third fluid modification device comprising a filter, such as a 1 μm polypropylene filter. The water then travels to a fourth fluid modification device comprising a UV radiation generator, such as a UV lamp which emits radiation at a wavelength capable of killing microbes and generating ozone. The ozone provides an antimicrobial affect, and has a half-life of about 20 minutes in water at 20° C., about 15 minutes in water at 25° C. and about 12 minutes in water at 30° C., such that the ozone provides an antimicrobial affect while the modified waste water is reused in the milk jug rinsing/washing apparatus. The fourth fluid modification device is in fluid communication with the milk jug rinsing/washing apparatus via a conduit separate from the conduit which supplies clean water to the milk jug rinsing/washing apparatus from the source of clean water.

After the modified waste water leaves the fourth fluid modification device, it is analyzed by an analyzing device, which is in electronic communication with the logic controller. The analyzing device may or may not be in fluid communication with the system, in that certain properties and/or contents of the modified waste water may be determined without the modified waste water contacting the analyzing device, while other properties and/or contents of the modified waste water may only be determined if the modified waste water is in contact with the analyzing device. Further, if the analyzing device is in fluid communication with the system, it may either be in series or parallel with the system.

The analyzing device may be capable of determining many properties and/or contents of the modified waste water, such as the BOD and/or the pH of the modified waste fluid. The analyzing device sends at least one signal to the logic controller, and the logic controller then determines whether the modified waste water is suitable for reuse in the milk jug rinsing/washing apparatus. If the logic controller determines that the water is suitable for reuse, the valve present on the incoming clean water conduit is oriented such that the modified waste fluid is supplied to the milk jug rinsing/washing apparatus, rather than clean water from the source of clean water. If the logic controller determines that the water is not suitable for reuse, the system enters maintenance mode, and the valve in fluid communication with the reservoir is oriented such that the system dumps the waste water into the sewer drain, and the valve present on the incoming clean water conduit is oriented such that clean water from the clean water source is supplied to the milk jug rinsing/washing apparatus.

In certain embodiments, the logic controller may only allow the system to operate in recycle mode if the level sensor present near the top of the reservoir indicates that the reservoir is holding a substantial amount of waste water, which ensures that there is enough waste water present in the reservoir such that the system will be able to modify the waste water and return it to the milk jug rinsing/washing apparatus before the reservoir becomes empty. In certain embodiments, the logic controller may determine that it is necessary to supply clean water from the source of clean water if the level sensor present near the bottom of the reservoir indicates that there is very little or no water remaining in the reservoir. This may or may not result in the system entering maintenance mode.

The logic controller may also be capable of determining whether a malfunction has occurred within the system, in which instance the system will enter maintenance mode. The logic controller may also be capable of receiving human input to force the system to enter maintenance mode. In certain embodiments, while in maintenance mode, the system may not operate until the logic controller determines that it is safe to operate the system and that the modified waste fluid is suitable for reuse in the milk jug rinsing/washing apparatus.

In a first embodiment of the present subject matter, provided is a system for use with a processing apparatus comprising a clean fluid entry portion and a waste fluid discharge portion, wherein the processing apparatus uses clean fluid in a process which results in the clean fluid becoming waste fluid; the system comprising: (a) a fluid modification apparatus comprising: (i) a first end capable of being in fluid communication with the waste fluid discharge portion; (ii) a second end capable of being in fluid communication with the clean fluid entry portion; and (iii) at least one fluid modification device in fluid communication with the first end and the second end, wherein the at least one fluid modification device modifies the waste fluid; (b) at least one analyzing device which determines: (i) whether the system is operating normally; and/or (ii) whether the modified waste fluid has become clean fluid; and (c) at least one fluid transport apparatus which returns the modified waste fluid to the processing apparatus, if the at least one analyzing device determines that the system is operating normally and/or that the modified waste fluid has become clean fluid.

The system of the first embodiment may include that the at least one analyzing device determines whether the system is operating normally. The at least one fluid transport apparatus may return the modified waste fluid to the processing apparatus if the system is operating normally.

The system of the first embodiment may include that the at least one analyzing device determines whether the modified waste fluid has become clean fluid. The at least one fluid transport apparatus may return the modified waste fluid to the processing apparatus if the at least one analyzing device determines that the modified waste fluid has become clean fluid.

The system of any of the first or subsequent embodiments may include that the waste fluid comprises a liquid.

The system of any of the first or subsequent embodiments may include that the waste fluid comprises water.

The system of any of the first or subsequent embodiments may include that the at least one fluid modification device comprises at least one of: at least one filter; at least one UV radiation generator; at least one heat exchanger; at least one pH modifier; at least one chemical introduction device; at least one deionization device; at least one sediment removal device; at least one strainer; at least one biological oxygen demand reducing device; at least one deodorizing device; or at least one decoloring device. The fluid modification apparatus may comprise a plurality of the at least one fluid modification devices arranged in series and/or in parallel. The at least one filter may comprise a filter having a pore size of about 0.2 to about 100 μm. The at least one filter may comprise at least one filter having a pore size of about 0.2 to about 5 μm and at least one filter having a pore size of about 10 to about 50 μm. The at least one UV radiation generator may comprise at least one of: (i) a lamp which generates radiation at a wavelength of about 254 nm; (ii) a lamp which generates radiation at a wavelength of about 185 nm; (iii) a lamp which generates radiation which provides an antimicrobial effect; (iv) a lamp which reduces the biological oxygen demand of the waste fluid; (v) a lamp which generates radiation which penetrates the DNA and/or RNA of bacteria; (vi) a lamp which generates radiation which at least partially disrupts the reproductive abilities of biological organisms; or (vii) a lamp which generates radiation which generates ozone in water.

The system of any of the first or subsequent embodiments may include that the at least one fluid transport apparatus comprises at least one pump.

The system of any of the first or subsequent embodiments may have a footprint of less than or equal to about 20 ft².

The system of any of the first or subsequent embodiments may further comprise at least one logic controller for controlling operation of the system.

The system of any of the first or subsequent embodiments may include that the system is modular.

The system of any of the first or subsequent embodiments may include that the system is comprised of modular components.

The system of any of the first or subsequent embodiments may include that the at least one analyzing device is capable of determining at least one of: the biological oxygen demand of the modified waste fluid; the pH of the modified waste fluid; the amount of ions present in the modified waste fluid; the temperature of the modified waste fluid; the amount of organic matter present in the modified waste fluid; the total suspended solids present in the modified waste fluid; or the color of the modified waste fluid.

In a second embodiment of the present subject matter, provided is a system comprising: (a) a processing apparatus comprising a clean fluid entry portion and a waste fluid discharge portion, wherein the processing apparatus uses clean fluid in a process which results in the clean fluid becoming waste fluid; (b) a fluid modification apparatus comprising: (i) a first end in fluid communication with the waste fluid discharge portion; (ii) a second end in fluid communication with the clean fluid entry portion; and (iii) at least one fluid modification device in fluid communication with the first end and the second end, wherein the at least one fluid modification device modifies the waste fluid; (c) at least one analyzing device which determines: (i) whether the system is operating normally; and/or (ii) whether the modified waste fluid has become clean fluid; and (d) at least one fluid transport apparatus which returns the modified waste fluid to the processing apparatus, if the at least one analyzing device determines that the system is operating normally and/or that the modified waste fluid has become clean fluid.

The system of the second embodiment may further comprise at least one reservoir comprising at least one of: (i) an inlet in fluid communication with the waste discharge portion of the processing apparatus and an outlet in fluid communication with the first end of the fluid modification apparatus; or (ii) an inlet in fluid communication with the second end of the fluid modification apparatus and an outlet in fluid communication with the clean fluid entry portion of the processing apparatus.

The system of either or both of the second or subsequent embodiments may further comprise a waste fluid collector in fluid communication with: (i) the inlet of the at least one reservoir; or (ii) the first end of the fluid modification apparatus.

The system of any of the second or subsequent embodiments may further include that the at least one reservoir contains from about 10 to about 60 gallons of fluid.

In a third embodiment of the present subject matter, provided is a method of modifying a waste fluid comprising: capturing the waste fluid from a process which results in a clean fluid becoming the waste fluid; modifying the waste fluid; ensuring that said modifying the waste fluid is occurring and/or analyzing the modified waste fluid to determine whether it has become clean fluid; and if said modifying the waste fluid is occurring and/or if the modified waste fluid has become clean fluid, returning the clean fluid to the process for reuse.

The method of the third embodiment may further include that the clean fluid is returned to the process for reuse if said modifying the waste fluid is occurring.

The method of either or both of the third or subsequent embodiments may further include that the clean fluid is returned to the process for reuse if the modified waste fluid has become clean fluid.

The method of any of the third or subsequent embodiments may further include that the waste fluid comprises a liquid.

The method of any of the third or subsequent embodiments may further include that the waste fluid comprises water.

The method of any of the third or subsequent embodiments may further comprise performing a process which uses clean fluid and results in the clean fluid becoming the waste fluid.

The method of any of the third or subsequent embodiments may further include that modifying the waste fluid comprises at least one of: filtering the waste fluid; subjecting the waste fluid to UV radiation; modifying the temperature and/or pressure of the waste fluid; modifying the pH of the waste fluid; introducing chemicals into the waste fluid; deionizing the waste fluid; removing sediment from the waste fluid; straining the waste fluid; reducing the BOD of the waste fluid; deodorizing the waste fluid; or decoloring the waste fluid.

The method of any of the third or subsequent embodiments may further comprise storing the waste fluid before and/or after performing one or more than one step of the method.

The method of any of the third or subsequent embodiments may further include that said modifying the waste fluid comprises passing the waste fluid through at least one fluid modification device. The at least one fluid modification device may comprise at least one of: at least one filter; at least one UV radiation generator; at least one heat exchanger; at least one pH modifier; at least one chemical introduction device; at least one deionization device; at least one sediment removal device; at least one strainer; at least one biological oxygen demand reducing device; at least one deodorizing device; or at least one decoloring device. The at least one filter may comprise a filter having a pore size of about 0.2 to about 100 μm. The at least one filter may comprise at least one filter having a pore size of about 0.2 to about 5 μm and at least one filter having a pore size of about 10 to about 50 μm. The at least one UV radiation generator may comprise at least one of: (i) a lamp which generates radiation at a wavelength of about 254 nm; (ii) a lamp which generates radiation at a wavelength of about 185 nm; (iii) a lamp which generates radiation which provides an antimicrobial effect; (iv) a lamp which reduces the biological oxygen demand of the waste fluid; (v) a lamp which generates radiation which penetrates the DNA and/or RNA of bacteria; (vi) a lamp which generates radiation which at least partially disrupts the reproductive abilities of biological organisms; or (vii) a lamp which generates radiation which generates ozone in water.

The method of any of the third or subsequent embodiments may further include that said analyzing the modified waste fluid to determine whether it has become clean fluid is based on at least one of: the biological oxygen demand of the modified waste fluid; the pH of the modified waste fluid; the amount of ions present in the modified waste fluid; the temperature of the modified waste fluid; the amount of organic matter present in the modified waste fluid; the total suspended solids present in the modified waste fluid; or the color of the modified waste fluid.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is:

1. A system for use with a processing apparatus comprising a clean fluid entry portion and a waste fluid discharge portion, wherein the processing apparatus uses clean fluid in a process which results in the clean fluid becoming waste fluid;
the system comprising:
a. a fluid modification apparatus comprising:
i. a first end capable of being in fluid communication with the waste fluid discharge portion;
ii. a second end capable of being in fluid communication with the clean fluid entry portion; and
iii. at least one fluid modification device in fluid communication with the first end and the second end, wherein the at least one fluid modification device modifies the waste fluid;
b. at least one analyzing device which determines: (i) whether the system is operating normally; and/or (ii) whether the modified waste fluid has become clean fluid; and
c. at least one fluid transport apparatus which returns the modified waste fluid to the processing apparatus, if the at least one analyzing device determines that the system is operating normally and/or that the modified waste fluid has become clean fluid.

2. The system of claim 1, wherein the at least one analyzing device determines whether the system is operating normally.

3. The system of claim 2, wherein the at least one fluid transport apparatus returns the modified waste fluid to the processing apparatus if the system is operating normally.

4. The system of claim 1, wherein the at least one analyzing device determines whether the modified waste fluid has become clean fluid.

5. The system of claim 4, wherein the at least one fluid transport apparatus returns the modified waste fluid to the processing apparatus if the at least one analyzing device determines that the modified waste fluid has become clean fluid.

6. The system of claim 1, wherein the waste fluid comprises a liquid.

7. The system of claim 1, wherein the waste fluid comprises water.

8. The system of claim 1, wherein the at least one fluid modification device comprises at least one of: at least one filter; at least one UV radiation generator; at least one heat exchanger; at least one pH modifier; at least one chemical introduction device; at least one deionization device; at least one sediment removal device; at least one strainer; at least one biological oxygen demand reducing device; at least one deodorizing device; or at least one decoloring device.

9. The system of claim 8, wherein the fluid modification apparatus comprises a plurality of the at least one fluid modification devices arranged in series and/or in parallel.

10. The system of claim 8, wherein the at least one filter comprises a filter having a pore size of about 0.2 to about 100 μm.

11. The system of claim 10, wherein the at least one filter comprises at least one filter having a pore size of about 0.2 to about 5 μm and at least one filter having a pore size of about 10 to about 50 μm.

12. The system of claim 8, wherein the at least one UV radiation generator comprises at least one of: (i) a lamp which generates radiation at a wavelength of about 254 nm; (ii) a lamp which generates radiation at a wavelength of about 185 nm; (iii) a lamp which generates radiation which provides an antimicrobial effect; (iv) a lamp which reduces the biological oxygen demand of the waste fluid; (v) a lamp which generates radiation which penetrates the DNA and/or RNA of bacteria; (vi) a lamp which generates radiation which at least partially disrupts the reproductive abilities of biological organisms; or (vii) a lamp which generates radiation which generates ozone in water.

13. The system of claim 1, wherein the at least one fluid transport apparatus comprises at least one pump.

14. The system of claim 1, having a footprint of less than or equal to about 20 ft².

15. The system of claim 1, further comprising at least one logic controller for controlling operation of the system.

16. The system of claim 1, wherein the system is modular.

17. The system of claim 1, wherein the system is comprised of modular components.

18. The system of claim 1, wherein the at least one analyzing device is capable of determining at least one of: the biological oxygen demand of the modified waste fluid; the pH of the modified waste fluid; the amount of ions present in the modified waste fluid; the temperature of the modified waste fluid; the amount of organic matter present in the modified waste fluid; the total suspended solids present in the modified waste fluid; or the color of the modified waste fluid.

19. A system comprising:
a. a processing apparatus comprising a clean fluid entry portion and a waste fluid discharge portion, wherein the processing apparatus uses clean fluid in a process which results in the clean fluid becoming waste fluid;
b. a fluid modification apparatus comprising:
i. a first end in fluid communication with the waste fluid discharge portion;
ii. a second end in fluid communication with the clean fluid entry portion; and
iii. at least one fluid modification device in fluid communication with the first end and the second end, wherein the at least one fluid modification device modifies the waste fluid;
c. at least one analyzing device which determines: (i) whether the system is operating normally; and/or (ii) whether the modified waste fluid has become clean fluid; and
d. at least one fluid transport apparatus which returns the modified waste fluid to the processing apparatus, if the at least one analyzing device determines that the system is operating normally and/or that the modified waste fluid has become clean fluid.

20. The system of claim 19, further comprising at least one reservoir comprising at least one of:
i. an inlet in fluid communication with the waste discharge portion of the processing apparatus and an outlet in fluid communication with the first end of the fluid modification apparatus; or
ii. an inlet in fluid communication with the second end of the fluid modification apparatus and an outlet in fluid communication with the clean fluid entry portion of the processing apparatus.

21. The system of claim 20, further comprising a waste fluid collector in fluid communication with: (i) the inlet of the at least one reservoir; or (ii) the first end of the fluid modification apparatus.

22. The system of claim 20, wherein the at least one reservoir contains from about 10 to about 60 gallons of fluid.

23. A method of modifying a waste fluid comprising:
capturing the waste fluid from a process which results in a clean fluid becoming the waste fluid;
modifying the waste fluid;
ensuring that said modifying the waste fluid is occurring and/or analyzing the modified waste fluid to determine whether it has become clean fluid; and
if said modifying the waste fluid is occurring and/or if the modified waste fluid has become clean fluid, returning the clean fluid to the process for reuse.

24. The method of claim 23, wherein the clean fluid is returned to the process for reuse if said modifying the waste fluid is occurring.

25. The method of claim 23, wherein the clean fluid is returned to the process for reuse if the modified waste fluid has become clean fluid.

26. The method of claim 23, wherein the waste fluid comprises a liquid.

27. The method of claim 24, wherein the waste fluid comprises water.

28. The method of claim 23, further comprising performing a process which uses clean fluid and results in the clean fluid becoming the waste fluid.

29. The method of claim 23, wherein modifying the waste fluid comprises at least one of: filtering the waste fluid; subjecting the waste fluid to UV radiation; modifying the temperature and/or pressure of the waste fluid; modifying the pH of the waste fluid; introducing chemicals into the waste fluid; deionizing the waste fluid; removing sediment from the waste fluid; straining the waste fluid; reducing the BOD of the waste fluid; deodorizing the waste fluid; or decoloring the waste fluid.

30. The method of claim 23, further comprising storing the waste fluid before and/or after performing one or more than one step of the method.

31. The method of claim 23, wherein said modifying the waste fluid comprises passing the waste fluid through at least one fluid modification device.

32. The method of claim 31, wherein the at least one fluid modification device comprises at least one of: at least one filter; at least one UV radiation generator; at least one heat exchanger; at least one pH modifier; at least one chemical introduction device; at least one deionization device; at least one sediment removal device; at least one strainer; at least one biological oxygen demand reducing device; at least one deodorizing device; or at least one decoloring device.

33. The method of claim 31, wherein the at least one filter comprises a filter having a pore size of about 0.2 to about 100 μm.

34. The method of claim 33, wherein the at least one filter comprises at least one filter having a pore size of about 0.2 to about 5 μm and at least one filter having a pore size of about 10 to about 50 μm.

35. The method of claim 31, wherein the at least one UV radiation generator comprises at least one of: (i) a lamp which generates radiation at a wavelength of about 254 nm; (ii) a lamp which generates radiation at a wavelength of about 185 nm; (iii) a lamp which generates radiation which provides an antimicrobial effect; (iv) a lamp which reduces the biological oxygen demand of the waste fluid; (v) a lamp which generates radiation which penetrates the DNA and/or RNA of bacteria; (vi) a lamp which generates radiation which at least partially disrupts the reproductive abilities of biological organisms; or (vii) a lamp which generates radiation which generates ozone in water.

36. The method of claim 23, wherein said analyzing the modified waste fluid to determine whether it has become clean fluid is based on at least one of: the biological oxygen demand of the modified waste fluid; the pH of the modified waste fluid; the amount of ions present in the modified waste fluid; the temperature of the modified waste fluid; the amount of organic matter present in the modified waste fluid; the total suspended solids present in the modified waste fluid; or the color of the modified waste fluid.
